(19) United States
(12) Patent Application Publication
(10) Pub. No.: US 2007/0008169 A1
(43) Pub. Date: Jan. 11, 2007

(54) A Radio Frequency Activated Integrated Circuit and Method of Disabling the Same

(76) Inventors: Ronald S Conero, San Diego, CA (US); Paul Atkinson, Poway, CA (US)

Correspondence Address: WILLIAM J. KOLEGRAFF, 3119 TURNBERRY WAY, JAMUL, CA, 91935, US

(21) Appl. No.: 11/456,680

(22) Filed: Jul. 11, 2006

Related U.S. Application Data
(60) Provisional application No. 60/698,548, filed on Jul. 11, 2005.

(51) Int. Cl. G08C 19/00

(52) U.S. Cl. 340/825.69; 340/10.5; 340/572.1

(57) ABSTRACT

An integrated circuit device is provided for attachment to a target. In one example, the integrated circuit device is a tag attached to a product such as an electronic device or optical disc. In another example, the integrated circuit device may be integrated into the product's circuitry. The integrated circuit is controllable to effect an action at the target, such as activating or deactivating the usefulness of the product. The integrated circuit has a logic and memory section connected to an antenna for receiving communications from an associated reader or scanner. The integrated circuit also has a component constructed to transition from a first state to a permanent second state. For example, the component may be a fuse, a partial fuse, or an anti-fuse. The integrated circuit also stores a hidden secret kill code, and upon receiving a matching kill code from the reader, permanently transitions the component to its second state. When the component is in the permanent second state, the integrated circuit is incapable of effecting the action on the target. In this way, the integrated circuits ability to affect the target may be permanently disabled. The integrated circuit may also verify its function is disabled, and report a kill confirmation to the reader.

### RELATED APPLICATIONS

This application claims priority to U.S. patent Application No. 60/698,548, filed Jul. 11, 2005, and entitled “Disabling a Radio Frequency Activated Integrated Circuit”, which is incorporated herein in its entirety.

### BACKGROUND

1. Field

The present invention relates to an integrated circuit that is capable of changing the utility of a target, and structures and processes for disabling the effect of the circuit. In a particular example, the invention uses radio frequency (RF) devices and processes to selectively and securely disable an integrated circuit from activating or deactivating a target device.

2. Description of Related Art

Manufacturers face a difficult problem in managing their distribution chains to assure products are safely and properly delivered to consumers. The manufacturer typically uses a distribution chain and retailers to bring its products to consumers. The manufacturer relies on the integrity of its distributors and retailers to assure that their products are properly sold or otherwise delivered. In a similar manner, the distributors and retailers rely on the manufacturer to provide a reliable product, and to assure that the product is delivered to them in proper condition. Building and maintaining such a trusted relationship between the manufacture, distributors and retailers is time consuming and takes considerable effort and resource to monitor. A particular problem exists in this relationship with the return of unsellable, damaged, or overstocked goods. Often, the cost of returning these goods to the manufacture exceeds the value of the product, so it would be more efficient for the retailer simply to discard the unsellable, damaged, or overstocked goods. The retailer could report how many goods were discarded, and the manufacturer might credit the retailer for the unsold goods. However, the retailer has an economic incentive to report some sold goods as discarded, so that the manufacturer would reimburse the cost of the good to the retailer. Since the manufacturer could lose significant revenue because of such over-reporting, the manufacture continues to require the physical return of goods. Because the manufacturer can not be certain that the retailer's discard reports are correct, the industry still relies on the costly and inefficient process of shipping the unsellable, damaged, or overstocked goods back to the manufacturer. The manufacturer then accounts for the returned goods, and provides an appropriate credit to the retailer.

Disposing of overstocked merchandise at retail outlets is a problem for manufacturers and retailers. Returning such merchandise to the manufacturer involves the time and expense of packaging, shipping, receiving, and handling the overstocked goods, not to mention the cost of documenting these activities. Retailers can choose instead to dispose of such merchandise directly rather than returning it to the manufacturer. However, both the retailer and the manufacturer need assurance that the merchandise has been destroyed or otherwise rendered valueless when disposed of, so that it is not later introduced into commerce.

The ability to build and maintain a trusted distribution network is important to all manufacturers, and is particularly critical in some product fields. For example, the distribution of pharmaceuticals, food products, and medical supplies require great trust between each party in the distribution chain. Unfortunately, commercial pressures may lead some distributors to act against the good of the entire distribution team, thereby eroding the trust and good-will built by the manufacturer. For example, a manufacturer may want to limit distribution to a select few high-end distributors, and therefore reaches exclusive distribution arrangements with a handful of premier distributors. In the agreement, each distributor may agree to sell products only in a specific geographic area, and to provide a high level of after-sale support in its area. In this way, the manufacturer may be confident that its product is sold and serviced in a way that maintains the highest of customer satisfaction and reputation. But, if one of the distributors is unable to sell its inventory in its assigned area, it may attempt to “dump” the product into the market using other channels. These products may be sold into other distributors exclusive areas, which will strain relations with those distributors, and may cause consumers to have undesirable service experience, which tarnishes the reputation of the manufacture and its products. It is therefore in the best interest of the manufacturer, the consumer, and the retailer to assure that products are properly sold, and to remove products from the distribution chain that are not being properly sold. Currently, manufacturer representatives manually police retail stores to assure products are sold through a proper distribution channel. This policing activity is not only inefficient, but strains relations with the retail outlets.

An example of this control is that which can be exercised over the distributors that are authorized to distribute a product. Manufacturers may want to control this in order to ensure that their product is appropriately positioned in the market and is affiliated with distributors with a particular profile or perceived quality. In addition, many products are stolen and redistributed to purchasers without their knowledge or in many cases without the knowledge of the direct distributor, the misappropriation having occurred earlier in the supply chain. This can negatively effect the purchaser's perception of the quality of the product as well as the level of product sales of the legitimate distributor. Moreover, if the manufacturer can provide assurances to retailers that its products cannot be sold and redistributed its products will have a higher value and can be positioned to command a higher price from the distributor.

### SUMMARY

Briefly, the present invention provides an integrated circuit device attached to a target. In one example, the integrated circuit device is a tag attached to or integrated with a product such as an electronic device or optical disc. In another example, the integrated circuit device may be integrated into the product's circuitry. The integrated circuit is controllable to effect an action at the target, such as activating or deactivating the usefulness of the product. The integrated circuit has a logic and memory section connected to an antenna for receiving communications from an associated reader or scanner. The integrated circuit also has a component constructed to transition from a first state to a permanent second state. For example, the component may be a fuse, a partial fuse, or an anti-fuse. The integrated circuit also stores a hidden secret kill code, and upon receiving a matching kill code from the reader, permanently transitions the component to its second state. When the component is in the permanent second state, the integrated circuit is incapable of effecting the action on the target. In this way, the integrated circuits ability to affect the target may be permanently disabled. The integrated circuit may also verify its function is disabled, and report a kill confirmation to the reader.

In one example, the integrated circuit is attached to an optical disc such as a DVD. The integrated circuit couples to an RF antenna for receiving data and power. The integrated circuit also has output ports connected to an electrochromic device, with the electrochromic device positioned over some important data on the disc. The optical disc is initially shipped with the electrochromic material in a darkened state, such that the DVD will not operate in an associated DVD player. If properly authorized, the integrated circuit is capable of transitioning the electrochromic material to a relatively transparent state, such that it activates the usefulness of the DVD so that it may be played. However, in some cases it may be desirable to cause the DVD to be permanently unplayable by disabling the ability of the integrated circuit to effect a change in the electrochromic material. Accordingly, the integrated circuit has a secret kill code in a write-once memory location. Upon receiving a matching kill code through the RF communication path, the integrated circuit causes a component to permanently transition to a second state. This component may be, for example, a fuse, a partial fuse, an anti-fuse, or a logic state. Upon transitioning the component, the integrated circuit is incapable of transitioning the electrochromic material to its transparent state. In this way, integrated circuit has been disabled from ever activating the DVD disc. The integrated circuit may also verify its ability to activate the disc is disabled, and report a kill confirmation to the reader. In this way, the retailer and manufacturer may be confident that the DVD has been permanently removed from the stream of commerce.

Advantageously, the present invention confidently and controllably allows products to be permanently disabled. In this way, manufacturers are enabled to more fully control the distribution of their products, and be assured that specific goods have been removed from the stream of commerce.

### BRIEF DESCRIPTION OF DRAWINGS

These and other features, aspects and advantages of the present invention will become better understood with regard to the following description, appended claims, and accompanying figures where:

FIG. 1A is a flow chart of a method for disabling an integrated circuit in accordance with the present invention.

FIG. 1B is a block diagram of a system for disabling an integrated circuit in accordance with the present invention.

FIG. 2 is a flow chart of a method for disabling an integrated circuit in accordance with the present invention.

FIG. 3 is a flow chart of a method for disabling an integrated circuit in accordance with the present invention.

FIG. 4 is a block diagram of an integrated circuit system that may be permanently disabled from performing an action in accordance with the present invention.

FIG. 5 is a block diagram of an integrated circuit system that may be permanently disabled from performing an action in accordance with the present invention.

FIG. 6 is a diagram showing the internal detail of the logic and memory block of the circuit illustrated in FIG. 5.

FIG. 7 is a flow chart illustrating steps for permanently disabling an integrated circuit system in accordance with the present invention.

FIG. 8 is a diagram illustrating the combined code and commands in one data sequence in accordance with the present invention.

FIG. 9 is a diagram of a command decoder circuit applying logic and memory functions associated with a deactivate command in accordance with the present invention.

FIG. 10 is a diagram showing internal detail of a logic and memory block including an encrypted KCVC for securely handling data and reducing the data storage requirements at an NOC in accordance with the present invention.

FIG. 11 is a block diagram of an integrated circuit system that may be permanently disabled from performing an action in accordance with the present invention.

FIG. 12 is a block diagram of an integrated circuit system that may be permanently disabled from performing an action in accordance with the present invention.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use. It will also be understood that selected detail information may not be illustrated to enable a more effective description of inventive structures.

### DETAILED DESCRIPTION

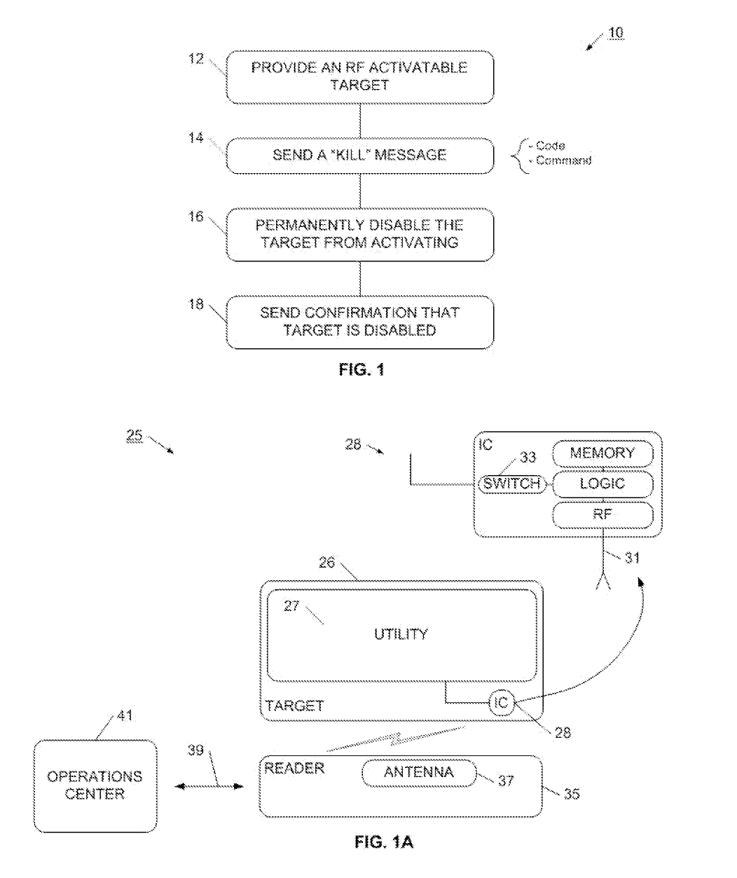

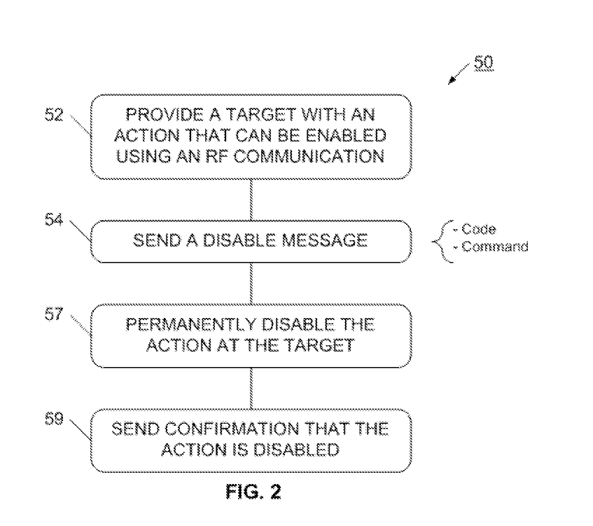

Referring now to FIG. 1, a method 10 for disabling a radio frequency integrated circuit is illustrated. Method 10 advantageously enables the manufacturer or seller of products to confidently confirm that products have been disabled, or to otherwise conveniently dispose of excess goods. Prior to fully describing method 10, it may be useful to generally describe the radio frequency integrated circuit, and the environment in which it operates. Referring now to FIG. 1A, a radio frequency activated RF system 25 is illustrated. System 25 may operate, for example, in a retail environment, or may be part of a home based activation system.

System 25 has target 26, which may be, for example, an optical disc such as a DVD, CD, gaming disc, HD DVD, or Blu-Ray DVD; the target may be an electronic device such as a portable music player, shaver, or drill; or the target may be a passport, driver's license, coupon, or other non-electronic good. It will be understood that target 26 may take other electronic or non-electronic forms. Target 26 has a utility 27, which is typically the primary usefulness for the target device. For example, if target 26 is a portable music player, then utility 27 is the ability to play music files. In another example, if target 26 is a DVD, then its primary utility 27 is to be read by an associated DVD player for presenting a movie or audio file to a user. Typically, utility 27 is the reason consumers are motivated to purchase or otherwise obtain target 26. Stated differently, if utility 27 were unavailable, and target 26 is not an attractive good for the consumer. In a similar way, the target would be unattractive for a thief or shoplifter. Further, by controlling a consumer's access to the utility of a product, a manufacturer is enabled to manage the rights to use the product. In this way, the manufacturer may set the conditions under which a consumer is able to use the physical product, and can even make the product forever unusable, thereby removing it from the stream of commerce. Importantly, this is all managed through a central network operations center, so does not require that the physical goods be returned to the manufacturer to be disabled.

Target 26 has a radio frequency integrated circuit 28. The integrated circuit 28 may be, for example, a tag attached to target 26, or may be integrally formed with other target circuitry or structures. Integrated circuit 28 couples to utility 27, and may selectively activate or deactivate the utility for target 26. For example, a DVD may initially be set such that it is unplayable in most DVD players, but upon an authorized sale, may have its utility activated. In this way, the DVD is unattractive to a thief or shoplifter while the DVD is in the distribution chain, but may be advantageously used by an authorized consumer. In another example, an electronic device has its power circuit disabled at the time of manufacture. The electronic device may then be moved through the distribution chain with a substantially reduced threat of theft. Since the electronic device would be unusable by any potential thief or shoplifter, it is far less likely that anyone will steal or otherwise misappropriate the device. However, at the point-of-sale and upon consummation of an authorized transaction, the power circuit for the electronic device may be activated. In this way, the authorized consumer may normally use the electronic device for its intended purpose.

An enlarged view of integrated circuit 28 shows that integrated circuit 28 has a memory, logic, and a radio frequency portion coupled to antenna 31. Upon receiving appropriate codes or commands via antenna 31, the integrated circuit may cause switch 33 to change states. More particularly, the RF section may receive codes or commands that the logic compares to commands or codes stored in memory. If the received codes match codes secretly stored in memory, then the integrated circuit may determine that an authorized code has been received. This command may, for example, cause the utility 27 to activate, or may cause the utility 27 to deactivate. In one state, switch 33 causes the utility 27 to be unavailable, and in another state causes the utility 27 to be fully available. It will be appreciated that switch 33 may be constructed with more than two states. However, for ease of explanation, switch 33 will be described as having only a deactivated state and an activated state.

It will be understood that switch 33 may take several forms. For example, switch 33 may be an electrochromic material that changes optical characteristics responsive to the application of a voltage. In another example, switch 33 may be fuse, anti-fuse, or other circuit device that is capable of changing electronic states. In yet another example, switch 33 may be a memory logic state, or a circuit device that has a voltage that may be sensed and understood as a logic value. It will also be understood that in some cases switch 33 main be persistently transitioned from a first state to a second state, and in other cases switch 33 may be reversible. In the case of a reversible switch, the reversibility function may also be selectively disabled. In one example, when the product or target is disabled, the reversibility function is likewise disabled.

At time of manufacture, IC 28 is typically set to disable utility 27 for target 26. In this way, target 26 is an unattractive theft target, as it is in an unusable or disabled state. At the point-of-sale, which may be a point-of-sale terminal in a retail establishment, a kiosk, or a home activation site, target 26 is placed proximate a reader 35. Reader 35 has an RF antenna 37 and RF transceiver for communicating with IC 28. When positioned proximate reader 35, IC 28 passes identifying information to reader 35, which then communicates the identifying information through a network connection 39 to an operations center 41. The operations center 41 generates or retrieves an activation or authorization code specific for target 26. The activation or authorization code is transmitted back to reader 35 and then communicated to target 26. Provided a proper code is received, the logic causes switch 33 to change state, and activate the utility 27 for target 26. In this way, the target has no or reduced utility through the distribution chain, but is efficiently activated at a point-of-sale.

Although the above description describes an activation process, in a more general case, the IC may be used to selectively make a range of functions available or unavailable, and may make some of these functions only temporarily available. In this sense, the IC and network processes are used to affect the utility of the target. The target with controllable utility may be an electronic device, or alternatively, may be a tangible media, such as an optical disc. The controlled target has a change effecting device that is set to a first state, which allows the target to operate according to a first utility. The controlled target also has a receiver for receiving an authorization key, and logic, which, responsive to the authorization key, selectively changes the change effecting device to a second state. When the change effecting device is in the second state, the target may operate according to a second utility. In one example, the controlled target has a restricted access key that was stored during manufacture, and the restricted access key is used by the logic in changing the state of the change effecting device. To change the utility of the controlled target, the controlled target is placed proximate to an activation device. The activation device may read an accessible identifier from the controlled target, and retrieve or generate an authorization key that is associated with the target. The activation device may cooperate with a network operation center or other entity to retrieve the authorization key, and to obtain approval to change the utility of the controlled target. If approved, the activation device may then send the authorization code to the controlled target.

A distribution control system is provided to support the controlled and selective changing of utility for a target. The target with controlled utility may be an electronic device, or alternatively, may be a tangible media, such as an optical disc. The distribution control system has a target with a change effecting device and a restricted access key. An activation device retrieves or generates an authorization key, and sends the authorization key to the target. The authorization key may be sent to the target wirelessly, for example, using a radio frequency signal. The target has logic that uses the restricted access key and the authorization key to change the utility of the target. In one example, the activation device retrieves the authorization key from a network operation center (NOC) by sending a target identifier to the NOC, and the NOC retrieves the authorization key for the identified target. The activation device may also connect to other systems for obtaining approval to change the utility of the target. For example, the authorization key may be sent to the target upon receiving payment, password, or other confirmation.

In a specific example of the distribution control system, a target is manufactured with a change effecting device set to compromise the utility of the target. In this way, the compromised target would be nearly useless to a thief, and therefore would be less likely to be a target of theft. The manufacturer has also stored an identifier and a restricted access key with the target. The manufacturer also stores the accessible identifier and its associated key for later retrieval by a party authorized to restore the utility to the target. In one example, the identifiers and keys are stored at a network operation center (NOC). The compromised target may be moved and transferred through the distribution chain with a substantially reduced threat of theft. When a consumer decides to purchase the target, the target is passed proximally to an activation device. Its accessible ID is read by activation device, and using a network connection to the NOC, sends the accessible ID. The NOC retrieves the authorization key for the target. Additional approvals may be obtained, for example, confirmation of payment, identification, password, or age. When approved, the activation device transmits the authorization key to the target, typically using a wireless communication. The target receives the authorization key, and using its logic, compares the authorization key to its stored restricted access key. If the keys match, then the target uses an activation power source to switch the state of the change effecting device. Then, the target will have full utility available to consumer.

Referring again to FIG. 1, the method 10 for disabling a radio frequency integrated circuit will be more fully described. Method 10 provides an RF activatable target as described with reference to 1A. The target has an attached or embedded IC, which selectively activates or deactivates the target. In some cases, it may be desirable to disable the ability of the integrated circuit to effect a change in utility, so a “kill” message may be sent to the integrated circuit. Typically, the kill message will be sent using an RF reader or other RF transceiver. For example, a retailer may have a quantity of recalled electronic devices. Rather than incurring the expense of sending the electronic devices back to the manufacturer, the retailer may pass each recalled electronic device by an RF transceiver. The RF transceiver sends a kill message to the IC on each device as shown in block 14. Responsive to receiving the kill message, the integrated circuit on the device is permanently disabled from activating the electronic device as shown in block 16. The manufacturer also may desire confirmation that all recalled and potentially dangerous products have been disabled, so the integrated circuit may report that it has been permanently disabled as shown in block 18. By permanently disabling the ability to activate the electronic device, and by confirming that the electronic device has been disabled, both the retailer and manufacturer can more effectively and efficiently respond to product recalls. In one use, even after being disabled, the processor may still have sufficient capability to allow for RF communications. In this way, a reader may still retrieve an ID from the target device, and receive a confirmation message that the product has been disabled. This information may be useful, for example, to identify a retailer attempting to activate or sell a disabled target.

In another example, a retailer may have an overstock of a particular DVD movie. In many cases, the cost to package the overstock DVDs, send the DVDs back to the distributor, and account for the returns, is more expensive then the cost of manufacturing the disc. Accordingly, it may be more economically desirable to permanently disabled the DVDs and recycle them, rather than return them to the distributor or studio. In such a case, the retailer may pass each DVD by an RF transceiver. The RF transceiver sends a kill message to the integrated circuit on the DVD, which causes the IC to permanently disable the ability to read the DVD. In one example, an electrochromic area of the DVD is made permanently opaque, rendering the disc unreadable. , Confirmation that the DVD has been disabled is returned to the RF transceiver, so that the distributor or studio may be confidently informed that the DVD has been removed from the stream of commerce.

As used herein, the following terms and variations thereof have the meanings given below, unless a different meaning is clearly intended by the context in which such term is used.

“Activate” refers to the enabling of a target to provide a feature, in particular a functional or other beneficial feature, or to allowing access to such a feature by an RFA IC (see definition, below). Activation can also refer to a change to a target that is instructed or made by the RFA IC, in particular a change that gives the target a utility that it did not have prior to activation. For example, activation of a target can comprise allowing a user access to content stored in the target, such as information stored on an optical disc.

“Deactivate” refers to rendering a feature of a target inoperative, so that the feature cannot be used or accessed, or to returning a target to the state or condition it was in prior to activation. Both activation and deactivation are generally reversible. In addition, the signals or codes instructing a RFA IC to activate or deactivate a target are preferably communicated in a secure manner in order to control such activation or deactivation, so that only conditional access to a controlled feature of a target is allowed.

“Disable,” with regard to RFA ICs, refers to rendering a RFA IC permanently incapable of activating, deactivating, or performing some other action with respect to the target with which it is in communication.

“Fusible Link” refers to a portion of a circuit in a RFA IC that becomes permanently disabled, i.e. unable to carry current, when the current-carrying capacity of the Fusible Link is exceeded. Other devices have a similar function. For example, a partial fuse is permanently disabled by transitioning from a low resistance state to a high resistance state, and an anti-fuse is permanently disabled by transitioning from a high resistance state to a low resistance state.

“Network Operations Center” or “NOC” refers to a facility for communicating with readers and with RFA ICs (via one or more readers). The NOC comprises a server, computer, or other device having data processing capability and the ability to communicate with such readers and with RFA ICs, preferably via a network connection. Functions of the NOC can be distributed over multiple locations and/or devices.

“Reader” refers to a device that provides an input signal, preferably an electromagnetic signal, to the present RFA IC. If the present RFA IC emits an electromagnetic signal in response, the reader is preferably configured to receive and process such signal. The overall function of a reader is to provide the means of communicating with RFA ICs and facilitating data transfer to or from RFA ICs.

“RFA IC” and “radio frequency activated integrated circuit” refer to a device having data processing capabilities and an interface for receiving input signals from a reader, which is also preferably capable of providing output signals to a reader. Radio frequency signals are preferred for the input interface but other types of signals, including electromagnetic signals of other frequencies, are also possible. RFA ICs are in communication with a target and also have an output interface to effect a change in a target. The RFA ICs described herein may include a Fusible Link and other circuitry for permanently disabling the ability of an RFA IC to perform functions such as activating or deactivating a target. RFA ICs can be active, i.e. powered by a battery or other power source, but preferably are passive and obtain operating power from signals sent by a reader, without a separate external power source. RFA ICs can be manufactured in ways known to the art for producing integrated circuits for RFID tags and similar devices.

“Target” refers to an article, item, or media in communication, typically electrically, with a RFA IC. Targets can be, for example, media for storing content such as audio, video, images, codes, and other types of data and information, in particular optical media such as compact discs (CDs), video discs, digital versatile discs (DVDs), laser discs, or holograms. Alternatively, the target can be an electronic device. RFA ICs are typically embedded in a target to prevent their unauthorized removal.

As used herein, the term “comprise” and variations of the term, such as “comprising ” and “comprises,” are not intended to exclude other additives, components, integers or steps. The terms “a,” “an,” and “the” and similar referents used herein are to be construed to cover both the singular and the plural unless their usage in context indicates otherwise.

Referring now to FIG. 2, a method for permanently disabling an action at a target is illustrated. Method 50 provides a target that can be affected by an action as shown in block 52. For example, the target may be activated or deactivated by an action. In another example, the target may be placed in a particular mode, or may have a particular subset of features enabled or disabled. In another example, the target may have the ability to selectively transmit information responsive to a request. It will be appreciated that a wide range of actions may be available on a target depending upon the particular type of target and application specific requirements. Typically, the target will be a tangible product with an attached or embedded integrated circuit. The integrated circuit cooperates with the target to selectively control the usability of the target, with the usability being defined according to a received action message. In some cases, it may be desirable to permanently disable one or more of the actions for the target. For example, it may be desirable that the target be permanently disabled from taking any action, while in other cases it may be desirable that a subset of available actions be disabled. Either way, the ability of the target to take particular actions is permanently disabled as shown in block 57. More particularly, the integrated circuit on the target receives the disable code or command, and upon confirmation that the code or command is authentic, the integrated circuit disables the ability of an action to be performed at the target. A confirmation message may be communicated from the integrated circuit to an associated reader to confirm that the action has been permanently disabled as shown in block 59.

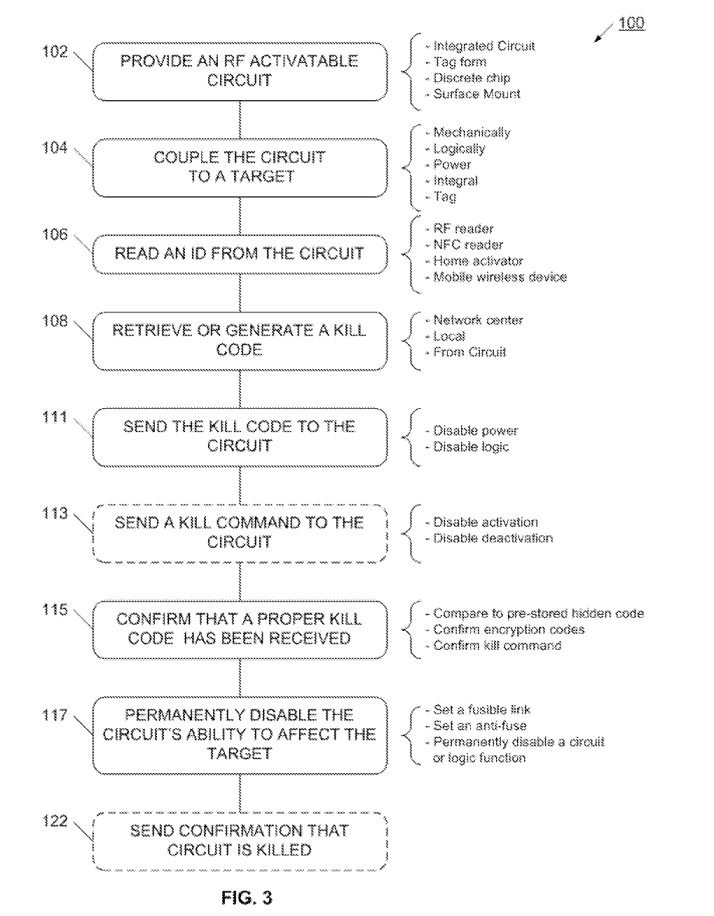

Referring now FIG. 3, a method for permanently disabling a target is illustrated. Method 100 provides an RF activatable integrated circuit as shown in block 102. The activatable integrated circuit may be integrally formed with target circuitry, attached to the target as a tag, removably attached to a product or packaging, may be provided as a discrete integrated circuit chip, or may be a surface mount integrated circuit device. It will be appreciated that the activatable circuit may be provided in other forms. The integrated circuit is coupled to some useful aspect of the target. It will be appreciated that the coupling characteristic will be defined according to the properties of the target. For example, the integrated circuit may connect to a logic portion of the target, thereby enabling control of a target function. In another example, the integrated circuit acts to switch power to the target, thereby enabling or disabling the ability of the target to power on. In other cases, the integrated circuit may coupled to other mechanical, logic, or power functions for selectively setting and activated or deactivated a state for the target. Typically, the integrated circuit is set by a manufacturer to disable the use of a target while the target is in the distribution chain. In normal operation, the target will be activated at a point of sale location when required conditions are met. For example, the target may be activated when an authorized retailer has received full payment for the target.

However, in some cases it may be desirable to permanently disable the target. In the case of overstock material, or for recalled products, it would be desirable that a product be permanently disabled and removed from the stream of commerce. In such a case, the target may be placed adjacent an RF reader. The reader may operate as part of a point-of-sale device, or may be a separate RF transceiver positioned in a stocking or merchandising area of a retailer. In another example, the reader may be part of a home activator system, or may even be part of a mobile wireless device. The RF reader may operate according to UHF frequencies, or may operate at a lower frequency for supporting near field communication processes. The reader reads an identification value from the circuit is showing in block 106. The ID value is sent to a network operations center, where a kill code is retrieved or generated specific to that target. This kill code may be retrieved or generated at the local level, at the network operations center level, or through a shared process. The reader then sends the kill code to the integrated circuit as shown in block 111. The kill code may be intended to disabled power for the target, or may disable logic or other aspects of the target that render the target undesirable for use. In some cases, a separate kill command may be sent as shown in block 113. The kill command may be used to more specifically identify the particular function to be disabled. By using both a kill code and a kill command, additional flexibility may be enabled.

The integrated circuit then confirms that a proper kill code or command has been received a shown block 115. The integrated circuit has been previously loaded with prestored hidden values. These hidden values are stored in a memory that is not accessible or readable from an external device, and are known only at the network center, or by an authorized agent. In this way, if the received kill command and code match the storied hidden code, then the integrated circuit has authenticated the kill function, and may proceed to permanently disable the device. Once the kill command has been authenticated, the integrated circuit permanently disables the ability to activate target as shown in block 117. The integrated circuit may, for example, permanently change a fuse such as a fusible link, partial fuse, or an anti-fuse to a detectable state such that an activate command can never be performed. In another example, the integrated circuit may permanently disable a circuit or logic function so that the activate command can never be performed. The integrated circuit may also send a confirmation to the transceiver or reader to confirm that the target has been permanently disabled a show in block 122. This information may then be used as a basis for confirmation reports that the target has been permanently disabled.

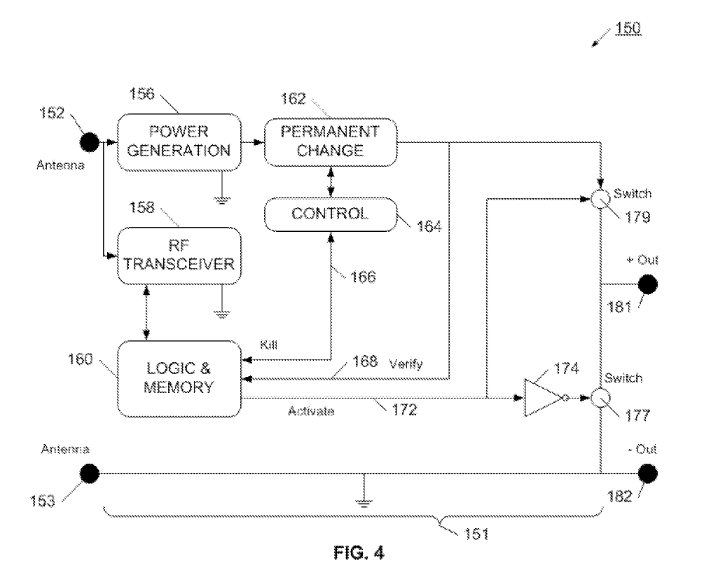

Referring now to FIG. 4, a system for disabling an activity is illustrated. A radio frequency activated integrated circuit, such as integrated circuit 151, is typically embedded within or otherwise electrically coupled to a target, and is able to communicate with a reader. In some situations, it may be desirable to permanently disable the ability of an RFA IC to activate or deactivate a target, or to provide some other function. For example, it may be desirable for a retailer to permanently disable the ability of an overstocked product to be activated for use, thus rendering it permanently valueless, so that the retailer can dispose of it directly rather than return it to the manufacturer. This can result in savings in paperwork, packaging, shipping, handling, and other expenses associated with returning the overstocked product. In addition to providing greater convenience for both the retailer and manufacturer, the savings from choosing to deactivate an overstocked product rather than return it will offset the product's replacement cost and thus be beneficial to both the retailer and the manufacturer. Manufacturers, however, need assurance that deactivated products have in fact been permanently disabled and rendered valueless, in order to prevent retailers from making claims that a the product has been permanently disabled when in fact it has not. Retailers who rely on third parties to permanently disable overstocked products can also benefit from such assurance.

System 150 may be implemented, at least in part, as an integrated circuit, or it may have more discreet component parts. As illustrated, system 150 has an integrated circuit 151, which has antenna inputs 152 and 153. The integrated circuit 151 is used to selectively activate or deactivate the utility of an attached target device, or may be used to implement other action commands. To effect the actions, integrated circuit 151 couples to the target through output contacts 181 and 182. In one example, the integrated circuit 151 is attached to or integrates with a DVD or other optical disc. One or more antennas are positioned on the disc and attach to antenna connections 152 and 153. Integrated circuit 151 may then establish a communication with a reader device to implement or effect actions, such as activating or deactivate access to the optical disk. In effecting the change, the integrated circuit provides output power to change the state of an electrochromic device. More particularly, the integrated circuit 151 has logic and control functions to direct, under approved conditions, power to the electrochromic device. In this regard, the electrochromic device electrically connects to output contacts 181 and 182. It will be appreciated the other switch devices may be substituted for the electrochromic device. It will also be appreciated that the power to activate the IC 151, as well as power the electrochromic device, is received from the RF signal received at the antenna.

Integrated circuit 151 receives an RF signal from antenna contacts 152 and 153. The RF signal may be, for example, a UHF signal operating at an RFID frequency, or may be an RF signal operating in the near field communication frequency. Integrated circuit 151 receives the RF signal and uses the RF signal for local power generation as shown in block 156. The power converted from the RF signal is used to both power the integrated circuit, and to provide sufficient power for driving the output contacts 181 and 182. Data received in the RF signal is received by RF transceiver 158. The RF transceiver 158 cooperates with logic and memory 162 to determine if authorized actions may be performed, and to direct power and signals to the output ports 181 and 182. For example, when proper authorization codes are received in the RF signal, an activate line 171 may be used to direct activating power to output ports 181 and 182.

More particularly, when logic and memory 160 has not placed a signal on activate line 172, that is, no action is currently being effected, then switch 179 is opened, while switch 177 is closed. In this way, both outputs 181 and 182 are pulled to ground. While in the ground state, these contacts are not able to effect a change on the target. However, when logic and memory 160 has determined to effect an action, the activate line 172 may be placed in a high state, which, through inverter 174, opens switch 177, and closes switch 179. In this arrangement, output pin 182 remains grounded, while power from power generation source 156 is available on port 181. This power then can be used to effect a change on the target.

In the process just described, component 162 is in a state that allows power to transfer from power generation source 156 to the switch 179, where it may be selectively applied to output port 181. However, in some cases it may be desirable to permanently disable the ability of integrated circuit 151 to effect a change in the target. When it is desired to make this change, the logic and memory may receive a “kill” command in the RF signal. Upon confirming that a proper kill command has been received, logic and memory 160 may provide a kill command to control module 164, which effects a permanent change in component 162. This permanent change disables the ability of power from power generation source 156 to be transmitted to switch 179. In this way, no activating, deactivating, or other action power may again be placed on port 181. In one example, component 162 may be a fusible link or other fuse. Typically, a fuse is understood to be a device that is normally a short or has relatively low resistance in its first temporary state, and in the second “blown” state has a high resistance or open state. In another example, component 162 may be an anti-fuse or other component that is capable of generating a detectable permanent second state. An anti-fuse is understood to be a device that is normally an open or has relatively high resistance in its first temporary state, and in the second “blown” state has a low resistance. Either way, the component 162 may be permanently changed from the first state to the permanent second state by the application of a relatively large burst of power.

Once the component 162 has been permanently placed in a disabled state, a verifying signal may be generated to confirm that integrated circuit has been permanently altered. For example, FIG. 4 shows a verify line 168 connected to component 162. When the power generation unit 156 is generating power, and a kill command has been performed, the verify line 168 will be at a low state. In this way, the logic and memory 160 may confirm that the component 162 has been permanently changed by monitoring the state of the verify line 168. It will be appreciated that the specific circuitry illustrated in FIG. 4 may be modified according to specific integrated circuit applications, or according to specific implementation requirements.

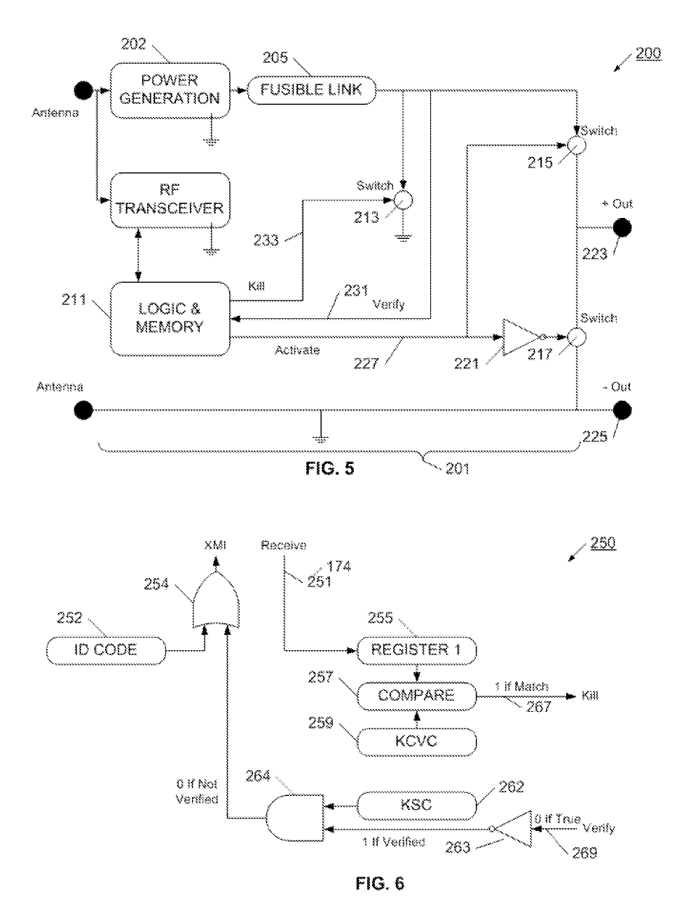

Referring now to FIG. 5, a system 200 for disabling an activity command is illustrated. In normal operation, the circuitry within the logic and memory block 211 of an RFA IC 201 will drive the activate line 227 to a logic 1 when proper activation criteria are met. This will cause switch 215 to turn on, and switch 217 to turn off via inverter 221. This results in the + out terminal 223 going to, for example, 4 volts (though any voltage within the operating voltage range of the RFA IC can be used), which is provided by the power generation circuit 202 through the fusible link 205. All the power for the output stage, switch 215, and switch 217 must come through the fusible link 205.

If it is desired to permanently disable the ability to activate or deactivate (i.e., “kill”) a target, a “kill command” can be sent via the reader to the circuitry in the logic and memory block 211. The kill command causes the kill line 233 to go high, which turns on switch 213. Switch 213 provides a direct short to ground for the 4 volt supply through the fusible link 205, which then blows open. This removes the 4 volt supply from output switch 215 and prevents the +out terminal 223 from ever going high. A verify line 231 is connected from the output side of the fusible link 205 back to the logic & memory block 211. Normally it will be at a logic 1 when the integrated circuit is powered. However, if the fusible link 205 is blown, it will indicate a logic 0, which provides robust confirmation that the ability to activate or deactivate a target has been permanently disabled. Since the fusible link 205 is a hardware component within the IC 201, software hackers will not be able to defeat the kill command once it has been completed and verified. The target at this point can never again be activated via the reader and its communication link.

Because the kill command results in a RFA IC which is permanently disabled and hence a target which cannot then be activated or deactivated, additional system safeguards may be desirable to ensure that accidental kill commands cannot be issued, and also to verify that the RFA IC was actually killed when commanded. In order to achieve this, two different secret codes can be stored in the RFA IC, typically during its manufacture. The codes are secret in that they cannot be obtained by direct interrogation of the RFA IC, i.e. prior knowledge of the codes is required. The first code is a kill command verification code (“KCVC”) which is stored in write-once-only memory in the RFA IC. The second secret code is a kill successful code (“KSC”) that is stored in write-once-only, read-many memory in the RFA IC. These two codes are different and are typically known only to the RFA IC network operations center (“NOC”). Both codes however, are directly associated with the RFA IC's identification code (“ID”). FIG. 6 shows the internal detail of the logic and memory block 250 associated with these functions.

In one embodiment of the system, when it is desired to permanently disable the RFA IC (and hence the ability to activate or deactivate the target associated with it), the reader requests the RFA's ID from the RFA IC 250. The ID is typically read out serially from the ID code memory location 252 in the logic and memory block 250 through logical “OR” gate 254, and transmitted to the NOC (e.g., using the XMI standard). The NOC associates the received ID with a previously stored KCVC, which it then sends to the RFA IC via the reader. The KCVC is received 251 and stored in Register 1 255 of the RFA IC's memory. The RFA IC also receives a kill command from or via the reader. Logic within the RFA IC then compares 257 the KCVC downloaded from the NOC, and stored in register 1, to the KCVC 259 stored in its write-only-once memory. If the codes match, the kill line 267 is asserted high. As previously described, this will blow the fusible link, and remove power from the output stage. If the fusible link is successfully blown, the verify line 269 will go low, which results in one input of “AND” gate 264 going high. The logic circuitry can then serially shift out the KSC 262 from the register connected to the other input of “AND” gate 264. This quasi-unique code is routed through logical “Or” gate 254 and transmitted via the reader to the NOC. The “AND” gate 254 serves a dual purpose of protecting the KSC 262 from being read out. Unless the fusible link blows, the verify line 269 will remain high, and the output of inverter 263 will be low. This will cause all 0's to be serially shifted out of “AND” gate 264, regardless of the code stored in the KSC register 262. Thus, a unique code, (e.g. all 0's) will be shifted out if the RFA IC has not be killed, and the actual KSC 262 cannot be read out when the RFA IC is still operational. Note that all 0's and all 1's are not allowed as kill successful codes.

It is important to note that the logical comparisons are being made within the RFA IC itself. The RFA IC does the logical test to see if the KCVC 259 matches what is stored in its internal memory, and also performs the logical comparison of the verify line 269 before enabling “AND” gate 264 to transmit the KSC 259 back to the NOC. When the KSC is received by the NOC, the database can then be updated to indicate that the target associated with that RFA IC has been permanently de-activated.

An alternate method can be used to simplify communications between the NOC, reader and the RFA IC. In one embodiment, rather than the RFA IC depending upon receipt of a kill command from or via the reader, the kill command can be automatically executed upon a successful comparison of a KCVC value downloaded to register 1 with an internal value stored in the KCVC write-once-only memory.

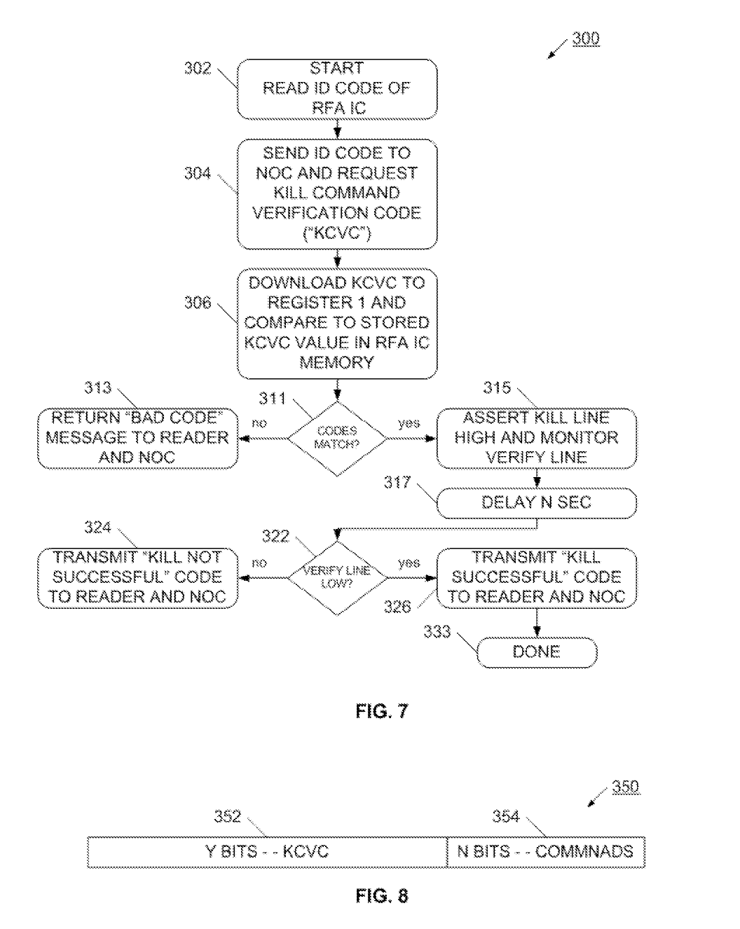

A flow chart of the kill sequence 300 is shown in FIG. 7. Kill sequence 300 starts by passing the integrated circuit and target near an RF reader. The RF reader may be, for example, a reader compliant with an RFID frequency, or an RF reader compliant with an NFC frequency. The RF reader reads an ID code from the integrated circuit as shown block 302. The reader sends the ID code to a network operations center as shown in block 304. In some cases the network operations center may determine that a kill code should be sent, and in other cases the reader may send a request for providing a kill code, also as shown in block 304. It will be understood that the initial request to kill the integrated circuits ability to affect the target may be made by any authorized entity. For example, a third party, such as a government agency, may desire to restrict the ability of a target to be activated. In such case, the government entity would notify the network operations center of the desire to kill the target, and thereby cause be network operations center to initiate the kill process after it receives the ID from the target The network operations center retrieves or generates a kill command verification code and transmits the code to the reader, which then transmits the kill code to the integrated circuit as shown in block 306.

The received kill command verification code is compared to the previously stored and hidden kill command verification code as shown in block 311. If the codes do not match, the reader is notified that a bad kill code has been perceived, and the integrated circuit does not proceed to disable its activity functions. However, if the codes do match, then the integrated circuit asserts its kill line high and begins to monitor the verify line is shown in block 315. The “delay N Sec” step 317 provides time for the fusible link to blow open. Logic in the integrated circuit checks the verify line as shown in block 322, and if the line is not toggled to a low state, then integrated circuit communicates a kill not successful code to the reader as shown in block 324. The reader may then notify the network operations center that the target may still be activatable or be able to perform other requested activities. However, in most cases the verify line will toggle to a low state, so the integrated circuit may transmit a kill successful code to the reader. In a similar manner, the kill successful notification may be sent to the reader and to the network operations center as shown in block 326, where the database for the target may be updated. Once the kill-successful code has reached the network operations center, the kill process is done as shown in block 333.

In another embodiment, the kill command can be added to or embedded within the KCVC. For instance, several additional bits can be added to the KCVC code to carry commands. Typically the KCVC can be 32 bits, but any number of bits can be used. If N additional bits are added to this code, then 2ˆN commands can be transmitted at the same time as the code itself. When the downloaded code is received, logic within the RFA IC strips out the bits associated with the command, and decodes them. If a kill command is downloaded and decoded, the RFA IC will know to kill the target as soon as the KCVC codes match. No additional commands need to be transmitted from the reader to the RFA IC. A data sequence 350 of the KCVC with added command bits is shown in FIG. 8. As an example, the KCVC 352 can be 32 bits long, which represents over 4 billion unique values, and the added command bits 354 can only be 8 bits long, which represent 256 different commands. Thus, by transmitting 40 bits of data, the RFA IC can execute 256 different commands or functions. Note that any command can be encoded with this method, not just the kill command, and can be transmitted with any other code or data, not just the KCVC.

Rather than adding additional bits, certain bits within the existing KCVC can alternatively be utilized to encode commands. For example, the first 8 bits or the last 8 bits can be used as the embedded “Command” field of the KCVC sequence. This has the effect of limiting the KCVC to 24 bits out of the 32 bit field, but that can be enough considering that these codes are also tied to the ID of the RFA IC, which can be 32 bits, for example. It is not necessary for the location of the command bits to be together within the KCVC data sequence. They can be distributed anywhere, in any order or fashion, within the data sequence. For instance, every 4th bit can be a command bit. Logic within the RFA IC can be connected to the proper bit locations in the receiving register, to decode the commands.

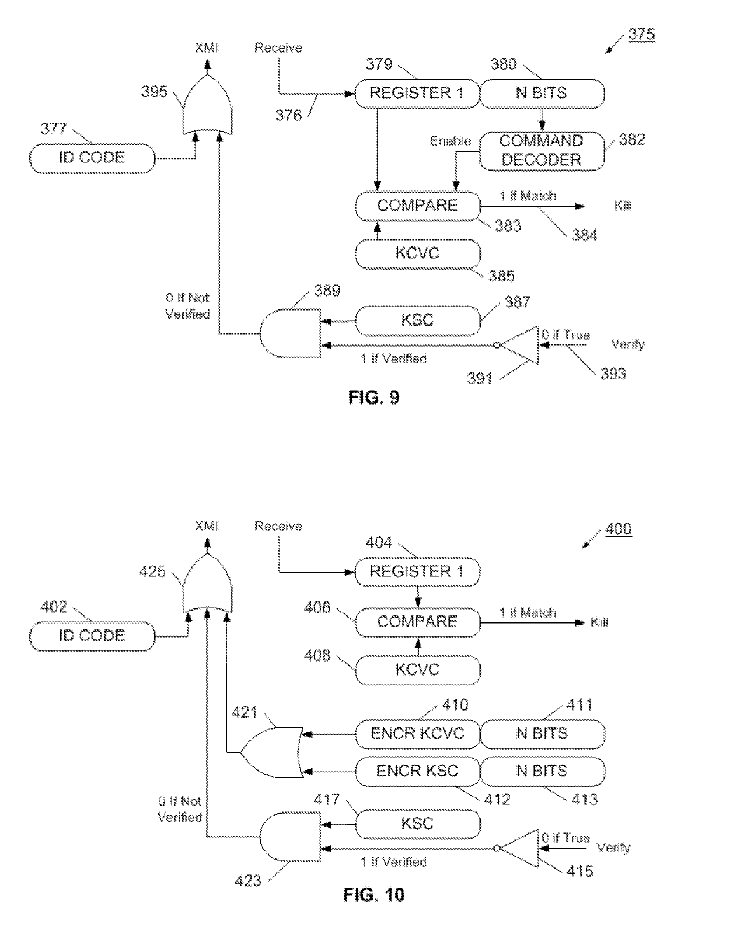

FIG. 9 shows an example of these concepts applied to the logic and memory function 375 associated with the kill command. The system of FIG. 9 is similar to the system described with reference to FIG. 6, so will be described in less detail. For example, ID 377, OR gate 395, receive line 376, success code 389, AND gate 389, inverter 391, and verify line 383 operate in a manner similar to components described with reference to FIG. 6. In FIG. 9, the additional N bits 380 that are added to the data sequence are decoded in the command decoder block 382. If a kill command is decoded, the enable line to the logic comparator 383 is asserted high. When the comparator 383 compares the code in Register 1 379 with the KCVC 385 stored in the RFA write-once-only memory it can immediately assert the kill line 384 if they match. The kill command has already been sent and decoded and has enabled the comparator.

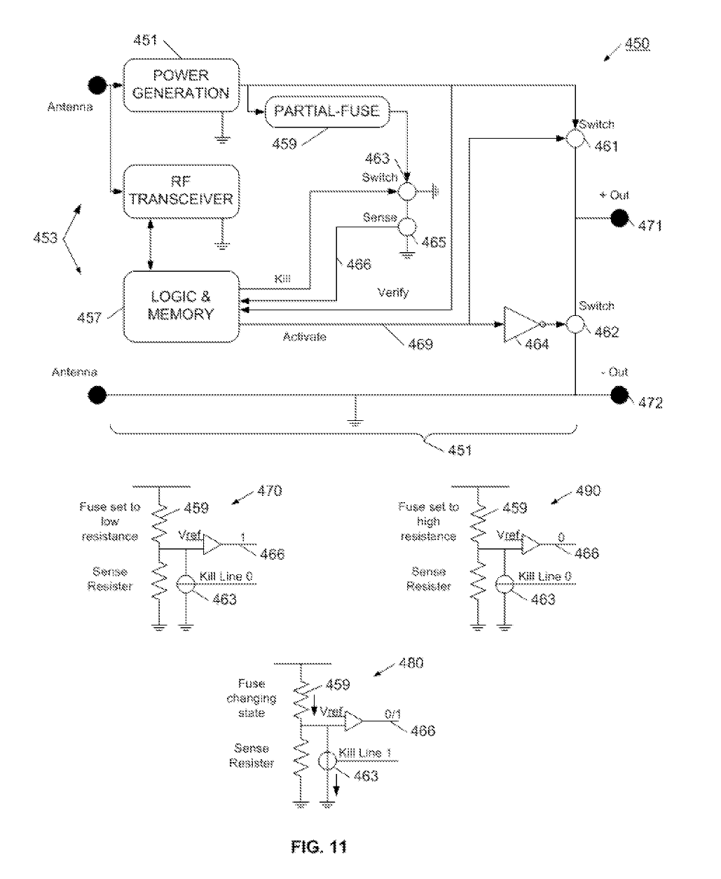

In some applications, the data storage and handling requirements for all the codes associated with the ID of the RFA IC's may be significant. In addition, the possibility for error due to data corruption in memory or transmission is significant, as may be the amount of time to locate the data at the NOC. A system 400 for reducing the data storage requirements at the NOC, and to handle the data more securely and robustly, is shown in FIG. 10. The system of FIG. 10 is similar to the system described with reference to FIG. 6, so will be described in less detail. In this implementation 400, in addition to the KCVC 408 and KSC 417 being stored in write-once-only memory, encrypted versions of these codes (“ENCR KCVC” 410 and “ENCR KSC” 411) are also stored in write-once-only memory. The encryption algorithm index used to encrypt these codes is also stored as an additional N bits added to each code (411 and 413, respectively). As an example, if N=4, then 2ˆN or 16 different encryption algorithms can be used to encrypt and subsequently, decrypt the data. When it is desired to kill the RFA IC, and therefore the target, the NOC requests, if it has not already done so, the ENCR KCVC, and ENCR KSC stored in write-once-only memory in the RFA IC via “OR” gates 421, and 425. The NOC will decode the added N bits of the ENCR KCVC, look up the decryption algorithm associated with that index, and decrypt the KCVC. This decrypted KCVC is downloaded to the RFA IC and stored in Register 1 404. The code in Register 1 404 is now compared 406 with the KCVC (not encrypted) stored in write-once-only memory. If the codes match, the RFA IC asserts the kill Line. Note that the logical decision to the kill the RFA IC (and hence the target) is still made within the RFA IC.

After the fusible link (FIG. 6) opens, the verify line will go low. Logic within the RFA IC will now transmit the KSC 417 from write-once-only memory via “AND” gate 423, and “OR” gate 425, to the NOC via the reader. The NOC will decode the added N bits of the ENCR KSC 412, which it received earlier, look up the decryption algorithm associated with that index, and decrypt the ENCR KSC 412. The NOC will then compare the decrypted ENCR KSC to the received KSC. If they match, the NOC has verified that the RFA IC (and also, therefore, the target) has been de-activated, or otherwise is disabled from performing certain actions.

Referring now to FIG. 11, a system 450 for disabling an activity command is illustrated. The system of FIG. 11 is similar to the system described with reference to FIG. 6, so will be described in less detail. In normal operation, the circuitry within the logic and memory block 457 of an RFA IC 451 will drive the activate line 469 to a logic 1 when proper activation criteria are met. This will cause switch 461 to turn on, and switch 462 to turn off via inverter 464. This results in the + out terminal 471 going to, for example, 4 volts (though any voltage within the operating voltage range of the RFA IC can be used), which is provided by the power generation circuit 451. A partial fuse 459 is used to determine if power is allowed to be coupled to the output 471.

If it is desired to permanently disable the ability to activate or deactivate (i.e., “kill”) a target, a “kill command” can be sent via the reader to the antenna 453 and circuitry in the logic and memory block 457. The kill command causes the kill line to go high, which turns on switch 463. Switch 463 provides a direct short to ground for the partial fuse 459, which then blows to a high resistance state. This allows the logic 457 to sense 465 the state of the partial fuse, and thereby never assert the activate line 469. By never asserting the activate line 469, the blown state of the partial fuse will prevent the + out terminal 461 from ever going high. A verify line 466 is connected from the output side of the power generation block 451 back to the logic & memory block 457. Normally it will be at a logical 1 when the integrated circuit is powered. However, if the partial fuse 459 is blown (in its persistent high-resistance state), it will indicate a logic 0, which provides robust confirmation that the ability to activate or deactivate a target has been permanently disabled. Since the partial fuse 459 is a hardware component within the IC 451, software hackers will not be able to defeat the kill command once it has been completed and verified. The target at this point can never again be activated via the reader and its communication link.

In some cases additional logic functions may be added to further reduce the chance of external hacking or spoofing of the circuit. These additional features may be introduced as hardware logic, so simply defeating or changing software functions would not be insufficient to activate a deactivated product. In one example, an AND gate (not illustrated) may be inserted in the activate line 469, with its inputs being attached to 1) the activate output of the Logic and Memory 457 and 2) the sense line 466. The output for the new AND gate would be the switch 461 and inverter 464. In this arrangement, if the sense line 466 is low (0) because the fusing device 459 is in its disabled state, then the output 471 can never be activated, even if the logic were spoofed and generated an activate signal. It will be appreciated that theses additional hardware security features may be implemented in alternative locations in the circuit, or may be combined with other circuit functions.

Arrangement 470 shows partial fuse 459 set to its initial low resistance state. A sense resistor is connected to ground and placed in series with the partial fuse. The voltage of the sense resistor is used as one input to a comparator, while a voltage reference is used as the other input. Since a relatively high current will pass through sense resistor, a relatively high voltage will be applied by the sense resistance to the comparator. Accordingly, the comparator outputs a logic 1 as shown on line 466. In this way, the logic and memory 457 senses that partial fuse 459 is in its initial low resistance state. Accordingly, the integrated circuit will act normally to activate, deactivate, or perform other activities as commanded and authenticated. Arrangement 480 shows the kill line has been asserted high, thereby coupling partial fuse 459 directly to ground. In this way, a surge of electrical current is passed through the partial fuse, causing partial fuse 459 to change from its initial low resistance state to a permanent high resistance state. As the fuse changes states, the state of sense line 466 may be ambiguous. However, as shown in arrangement 490, after the partial fuse completes transition to its high resistance state, the sense line 466 is held persistently in its low state. More particularly, only a small amount of current is allowed to pass through the sense resistor, thereby setting the voltage relatively low as compared to the voltage reference. Accordingly, the compare component outputs a logic 0. Logic and memory 457 detects the logic 0 state, and is coded to never allow the activate line 469 to be asserted. Since the transition of the partial fuse 459 to its high resistance state is permanent, logic and memory 457 is never allowed to assert the activate line, thereby permanently disabling the ability of the integrated circuit to effect a change in the target.

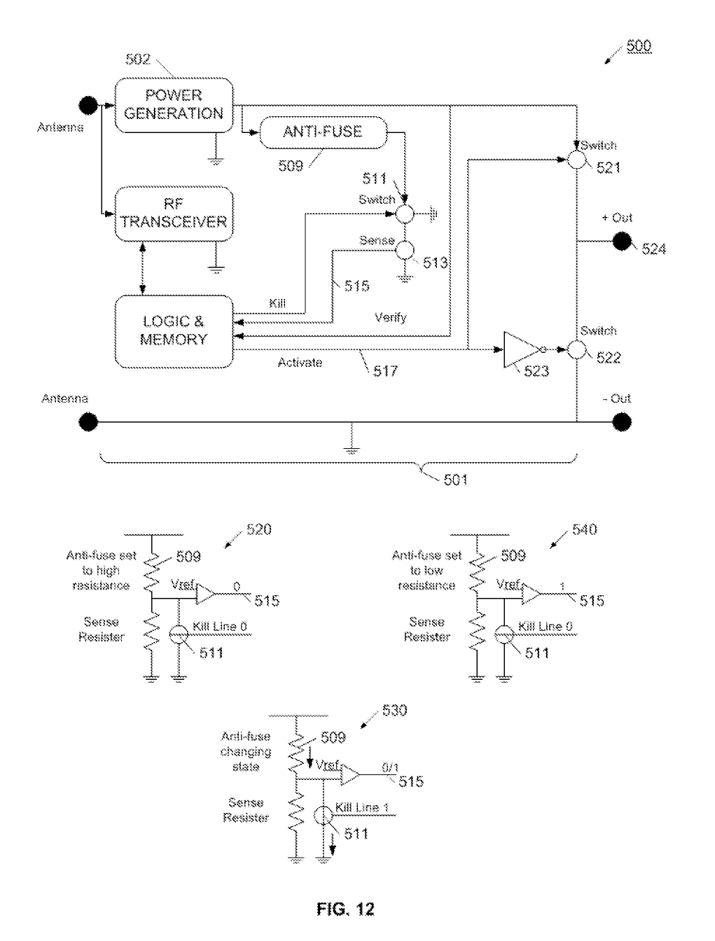

Referring now to FIG. 12, a system 500 for disabling an activity command is illustrated. The system of FIG. 12 is similar to the systems described with reference to FIG. 6 and FIG. 11, so will be described in less detail. In normal operation, the circuitry within the logic and memory block of an RFA IC 501 will drive the activate line 517 to a logic 1 when proper activation criteria are met. This will cause switch 521 to turn on, and switch 522 to turn off via inverter 523. This results in the + out terminal 524 going to, for example, 4 volts (though any voltage within the operating voltage range of the RFA IC can be used), which is provided by the power generation circuit 502. An anti-fuse 509 is used to determine if power is allowed to be coupled to the output 524.

If it is desired to permanently disable the ability to activate or deactivate (i.e., “kill”) a target, a “kill command” can be sent via the reader to the antenna and circuitry in the logic and memory block. The kill command causes the kill line to go high, which turns on switch 511. Switch 511 provides a direct short to ground for the anti-fuse 509, which then blows to a low resistance state. This allows the logic to sense 513 the state of the anti-fuse, and thereby never assert the activate line 517. By never asserting the activate line 517, the blown state of the anti-fuse will prevent the + out terminal 521 from ever going high. A verify line is connected from the output side of the power generation block 502 back to the logic and memory block. Normally it will be at a logic 1 when the integrated circuit is powered. However, if the anti-fuse 509 is blown (in its persistent low-resistance state), it will indicate a logic 0, which provides robust confirmation that the ability to activate or deactivate a target has been permanently disabled. Since the partial fuse 509 is a hardware component within the IC 501, software hackers will not be able to defeat the kill command once it has been completed and verified. The target at this point can never again be activated via the reader and its communication link.

In some cases additional logic functions may be added to further reduce the chance of external hacking or spoofing of the circuit. These additional features may be introduced as hardware logic, so simply defeating or changing software functions would not be insufficient to activate a deactivated product. In one example, an AND gate (not illustrated) may be inserted in the activate line 469, with its inputs being attached to 1) the activate output of the Logic and Memory and 2) the sense line 515. The output for the new AND gate would be the switch 521 and inverter 523. In this arrangement, if the sense line 515 is low (0) because the fusing device 509 is in its disabled state, then the output 524 can never be activated, even if the logic were spoofed and generated an activate signal. It will be appreciated that theses additional hardware security features may be implemented in alternative locations in the circuit, or may be combined with other circuit functions.

Arrangement 520 shows anti-fuse 509 set to its initial high resistance state. A sense resistor is connected to ground and placed in series with the anti-fuse. The voltage of the sense resistor is used as one input to a comparator, while a voltage reference is used as the other input. Since a relatively low current will pass through sense resistor, a relatively low voltage will be applied by the sense resistance to the comparator. Accordingly, the comparator outputs a logic 0 as shown on line 515. In this way, the logic and memory block senses that anti-fuse 509 is in its initial high resistance state. Accordingly, the integrated circuit will act normally to activate, deactivate, or perform other activities as commanded and authenticated. Arrangement 540 shows the kill line has been asserted high, thereby coupling anti-fuse 509 directly to ground. In this way, a surge of electrical current is passed through the anti-fuse 509, causing anti-fuse 509 to change from its initial high resistance state to a permanent low resistance state. As the fuse changes states, the state of sense line 515 may be ambiguous. However, as shown in arrangement 540, after the anti-fuse 509 completes transition to its low resistance state, the sense line 515 is held persistently in its high state. More particularly, a relatively large amount of current is allowed to pass through the sense resistor, thereby setting the voltage relatively high as compared to the voltage reference. Accordingly, the compare component outputs a logic 1. The logic and memory block detects the logical 1 state, and is coded to never allow the activate line 517 to be asserted. Since the transition of the anti-fuse 509 to its low resistance state is permanent, the logic and memory block is never allowed to assert the activate line 517, thereby permanently disabling the ability of the integrated circuit to effect a change in the target. Although different types of fuses, such as fuses, partial fuses, and anti-fuses, have been described, it will be understood that other components or logic arrangements may be used to permanently disable the ability of an integrated circuit to effect an action on a target device.

The foregoing techniques can be applied to any of the data sequences, commands, stored memory values, and functions associated with the RFA IC. They are not limited to only the kill command and associated data stored in memory. Although the present invention has been discussed in considerable detail with reference to certain preferred embodiments, other embodiments are possible. The steps disclosed for the present methods are not intended to be limiting nor are they intended to indicate that each step depicted is essential to the method, but instead are exemplary steps only. Therefore, the scope of the appended claims should not be limited to the description of preferred embodiments contained in this disclosure.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. An integrated circuit device, comprising:
a logic and memory section connectable to an antenna;
a component constructed to transition from a first state to a permanent second state;
a hidden memory storing a secret kill code;
a receiver configured to receive a kill message; and
wherein the component is transitioned to the permanent second state responsive to the logic comparing the secret kill code to the received kill message.

2. The integrated circuit device according to claim 1, further comprising a verify line arranged to pass a confirmation signal to the logic when the component is in its permanent second state.

3. The integrated circuit device according to claim 1, further comprising another hidden memory storing a secret kill-successful code.

4. The integrated circuit device according to claim 1, further comprising a readable memory storing an encrypted version of the secret kill-successful code.

5. The integrated circuit device according to claim 1, further comprising a readable memory storing an encrypted version of the secret kill code.

6. The integrated circuit device according to claim 1, further comprising a readable memory storing an identification for an associated target device.

7. The integrated circuit device according to claim 1, further comprising a power output port that is permanently disabled responsive to the component being in the permanent second state.

8. The integrated circuit device according to claim 1, wherein the antenna is an RF antenna constructed to receive a UHF signal.

9. The integrated circuit device according to claim 1, wherein the antenna is an RF antenna constructed to receive an RFID signal.

10. The integrated circuit device according to claim 1, wherein the antenna is an RF antenna constructed to receive a near field communication signal.

11. The integrated circuit device according to claim 1, wherein logic and memory section are formed on a tag.

12. The integrated circuit device according to claim 1, wherein logic and memory section are formed integrally with target circuitry.

13. The integrated circuit device according to claim 12, wherein the target is an electronic device or an optical disc.

14. The integrated circuit device according to claim 1, wherein the component is a fuse.

15. The integrated circuit device according to claim 1, wherein the component is a partial fuse.

16. The integrated circuit device according to claim 1, wherein the component is an anti-fuse.

17. The integrated circuit device according to claim 1, wherein the component is a memory location.

18. A process for disabling an integrated circuit device from effecting an action at a target, comprising:
receiving an identification read from the integrated circuit device associated with the target;
receiving encrypted data read from the integrated circuit device associated with the target;
decrypting the encrypted data to generate a kill code;
transmitting the kill code to the integrated circuit device.

19. The method according to claim 18, further comprising the step of receiving a confirmation message that the integrated circuit device is disabled from effecting the action at the target.

20. The method according to claim 18, further comprising the steps of:
receiving encrypted kill-successful data from the integrated circuit device associated with the target;
receiving a kill-successful message from the integrated circuit device associated with the target;
decrypting the encrypted kill-successful data to generate kill-successful data;
comparing the received kill-successful message to the generated kill-successful data; and
confirming, responsive to the comparison, that the integrated circuit is disabled.

21. The method according to claim 20, further comprising the step of receiving encryption information from the integrated circuit device for identifying the decryption process for the kill-successful data.

22. The method according to claim 18, further comprising the step of receiving encryption information from the integrated circuit device for identifying the decryption process.

23. A process for permanently disabling an integrated circuit device from effecting an action at a target, the process operating on the integrated circuit device, comprising:
holding a secret kill code in a memory;
transmitting an identification;
transmitting an encrypted version of the secret kill code;
receiving a kill code;
comparing the kill code to the secret kill code; and
permanently disabling, responsive to the comparison, the integrated circuit device from effecting the action at the target.

24. The method according to claim 23, further comprising the step of transmitting a confirmation message that the integrated circuit device is disabled from effecting the action at the target.

25. The method according to claim 23, wherein the transmitting and receiving steps comprise using an RF communication.

26. The method according to claim 23, wherein the step of permanently disabling the integrated circuit device from effecting the action at the target comprises permanently setting a fuse to an open state.

27. The method according to claim 23, wherein the step of permanently disabling the integrated circuit device from effecting the action at the target comprises permanently setting a fuse to a high-resistance state.

28. The method according to claim 23, wherein the step of permanently disabling the integrated circuit device from effecting the action at the target comprises permanently setting an anti-fuse to a low resistance state.

29. The method according to claim 23, further including the steps of:
holding a kill-successful code in a memory;
verifying that the integrated circuit is disabled from effecting the action at the target; and
transmitting, responsive to the verification, the kill-successful code.

30. The method according to claim 23, further including the steps of:
holding a kill-successful code in a memory;
transmitting an encrypted version of the kill-successful code;
verifying that the integrated circuit is disabled from effecting the action at the target; and
transmitting, responsive to the verification, the kill-successful code.

31. An integrated circuit system, comprising:
an antenna;
an output port for connection to a target device, the output port capable of effecting a change at the target;
a logic and memory section connected to the antenna;
a receiver configured to receive a kill message; and
a kill circuit for disabling the output port's capability to effect the change, the kill circuit operating responsive to the kill message.

32. The integrated circuit system according to claim 31, wherein the kill circuit comprises a fuse, a partial fuse, an anti-fuse, or a detectable logic state.

33. The integrated circuit system according to claim 31, wherein the kill circuit comprises a component that is transitioned from a first state to a permanent second state responsive to the kill message.

34. The integrated circuit system according to claim 31, wherein the kill circuit comprises a component that is transitioned from a first state to a second state responsive to the kill message.

35. The integrated circuit system according to claim 31, wherein the kill circuit permanently disables the output port's capability to effect the change at the target.

36. The integrated circuit system according to claim 31, further comprising a verification circuit for verifying that the output port's capability has been disabled.

37. The integrated circuit system according to claim 31, further comprising a confirmation circuit for transmitting a confirmation message that the output port's capability has been disabled.

38. The integrated circuit system according to claim 31, further comprising an inaccessible hardware logic device connected to the kill circuit and arranged to prevent activation of the output port.

39. The integrated circuit system according to claim 38, wherein the hardware logic unit has one input connected to the kill circuit and another input connected to an activation output from the logic and memory section, and the output for the hardware logic unit is arranged to activate the output port.

40. The integrated circuit system according to claim 39, wherein the output port is not activated when the kill circuit is “off” and the activation output is “on”.
